(19) United States
(12) Patent Application Publication
(10) Pub. No.: US 2006/0209876 A1
(43) Pub. Date: Sep. 21, 2006

(54) Access point using directional antennas for uplink transmission in a WLAN

(75) Inventors: Kai Liu, Melville, NY (US); Carl Wang, Flushing, NY (US); Arty Chandra, Manhasset Hills, NY (US); Jin Wang, Central Islip, NY (US)

Correspondence Address: MICHAEL W. TAYLOR, P.O. BOX 3791, ORLANDO, FL, 32802-3791, US

(73) Assignee: InterDigital Technology Corporation, Wilmington, DE (US)

(21) Appl. No.: 11/343,397

(22) Filed: Jan. 31, 2006

Related U.S. Application Data
(60) Provisional application No. 60/651,607, filed on Feb. 10, 2005.

(51) Int. Cl. H04L 12/413

(52) U.S. Cl. 370/445; 370/338; 370/352

(57) ABSTRACT

An access point receives uplink transmissions from client stations using directional antenna beams. The directional antenna beams are generated by an antenna array. The different directional antenna beams are assigned beam identification numbers, and a preferred antenna beam is selected for each client station. The client stations in the different antenna beam regions initiate their uplink transmissions using assigned backoff slots within the contention window. The access point selects the preferred directional antenna beam corresponding to the directional antenna beams assigned to the backoff slots.

### RELATED APPLICATION

This application claims the benefit of U.S. Provisional Application Ser. No. 60/651,607 filed Feb. 10, 2005, the entire contents of which are incorporated herein by reference.

### FIELD OF THE INVENTION

The present invention relates to the field of wireless communications, and more particularly, to an access point operating with a directional antenna in an 802.11 wireless local area network (WLAN).

### Background of the Invention

In an 802.11 wireless local area network, an access point (AP) exchanges data with wireless users. The wireless users are also known as client stations (CS). Example client stations are personal computers operating with a wireless network card. An access point includes an antenna for sending downlink signals to the client stations. The access point is also responsible for receiving uplink signals transmitted from each client station.

The most common type of antenna used to transmit and receive signals at an access point is an omni-directional monopole antenna. This type of antenna comprises a single wire or antenna element that is coupled to a transceiver within the access point. The transceiver receives reverse link signals transmitted from a client station, and transmits forward link signals to that client station.

The transmitted signals sent from a monopole antenna are omni-directional in nature. That is, the signals are sent with the same signal strength in all directions in a generally horizontal plane. Reception of signals with the monopole antenna element is likewise omni-directional. A monopole antenna does not differentiate in its ability to detect a signal in one direction versus detection of the same or a different signal coming from another direction. As a result, the antenna gain of an omni-directional antenna is generally low, resulting in a reduced range in which client stations can access the network via the access point. Moreover, the throughput of the network is adversely affected by low gain omni-directional antennas.

To improve performance, an access point can use a directional antenna for downlink transmissions, but typically does not receive uplink transmissions with the directional antenna because it cannot predict when and where the next client station will transmit. One approach for an access point to use a directional antenna is for the client station to send a request-to-send (RTS) packet before transmitting each data packet. The access point receives the RTS packet via an omni-directional antenna and then switches to a directional antenna for receiving the following uplink data packet. A drawback for this approach is the extra overhead associated with the data packet transmission, especially for small data packets.

Another approach is to use a contention free period (CFP). The access point controls the uplink transmission by polling the client stations. A client station can transmit only after being polled by the access point. However, the CFP is optional and is not implemented by most manufacturers. In addition, overhead is introduced since the access point does not know which client station has data to transmit. In a worst case, the access point has to poll all of the client stations to find one that has data to transmit.

### SUMMARY OF THE INVENTION

In view of the foregoing background, it is therefore an object of the present invention to provide access point that receives uplink transmissions using a directional antenna beam without introducing overhead to the uplink transmissions.

This and other objects, features, and advantages in accordance with the present invention are provided by a method for providing uplink transmissions in an 802.11 wireless communication network between a plurality of client stations and an access point, with the access point operating with an antenna array generating N antenna beams, and with the uplink transmissions occurring during a contention window comprising a plurality of backoff slots. The method comprises assigning a beam identification number to each of the N antenna beams, selecting a preferred antenna beam for each client station associated with the access point, and assigning an IP address to each client station. A modulo N of each assigned IP address may be equal to the beam identification number corresponding to the preferred antenna beam selected to that client station.

The method further comprises dividing the plurality of backoff slots into N groups, with each group of backoff slots corresponding to one of the N antenna beams and being assigned to the client stations having that particular antenna beam selected as its preferred antenna beam. The access point selects one of the N antenna beams to receive uplink transmissions from the client stations having that particular antenna beam selected as its preferred antenna beam, with the uplink transmissions occurring in the backoff slots assigned to these client stations.

The N antenna beams include an omni-directional antenna beam and a plurality of directional antenna beams. The use of directional antenna beams during uplink transmissions from the client stations improve the throughput of the WLAN, and increase the communication range between the access point and the client stations. This is advantageously done without introducing overhead to the uplink transmissions.

Each group of backoff slots is divided such that a modulo N of each backoff slot position in any particular group equals the beam identification number assigned to the client stations having this particular group of backoff slots. The contention window comprises 1023 backoff slots.

The 802.11 wireless communication network is operating in a distributed coordinated function (DCF) mode. The method may further comprise each client station sensing if a communications channel is idle, and if so, then waiting a distributed interframe space (DIFS) period before initiating uplink transmission to the access point on its assigned backoff slots within the contention window.

If a communications channel is idle, and there are no uplink transmissions after the plurality of backoff slots has passed, then the access point may select the omni-directional antenna beam as the preferred antenna beam for any client station initiating uplink transmissions with the access point.

If the access point determines that a client station has moved so that its preferred antenna beam needs to be updated, then the access point stops transmitting to the client station, updates the preferred antenna beam and updates the assigned IP address based upon the beam id corresponding to the updated preferred antenna beam.

Another aspect of the present invention is directed to an access point comprising an antenna array generating N antenna beams, and a controller coupled to the antenna array for selecting one of the N antenna beams for receiving uplink transmissions from client stations occurring during a contention window comprising a plurality of backoff slots. A transceiver is coupled to the controller and to the antenna array and comprises a backoff algorithm module for performing the above method.

### BRIEF DESCRIPTION OF THE DRAWINGS

FIG. 1 is a schematic diagram of a WLAN including client stations, and an access point operating with an antenna array generating an omni-directional antenna beam and directional antenna beams in accordance with the present invention.

FIG. 2 is a block diagram of the access point illustrated in FIG. 1.

FIG. 3 is a time line illustrating the DCF mode in an 802.11 WLAN in accordance with the present invention.

FIG. 4 is a flowchart for providing uplink transmissions in an 802.11 wireless communication network between client stations and an access point in accordance with the present invention.

FIG. 5 is an address allocation scheme for the client stations associated with the access point shown in FIG. 1.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

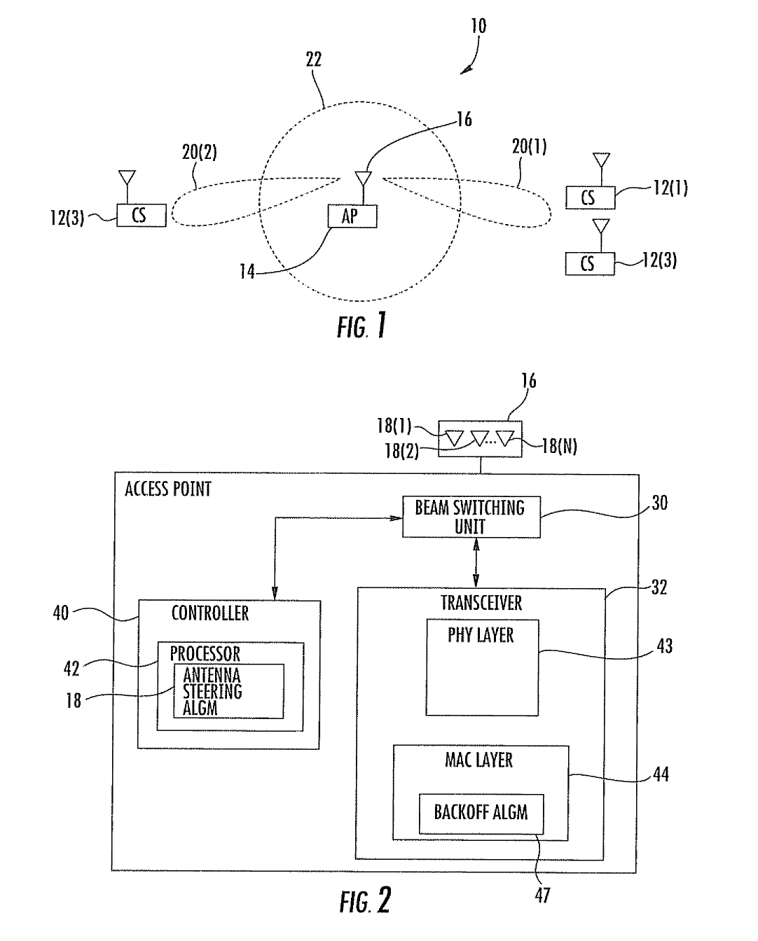

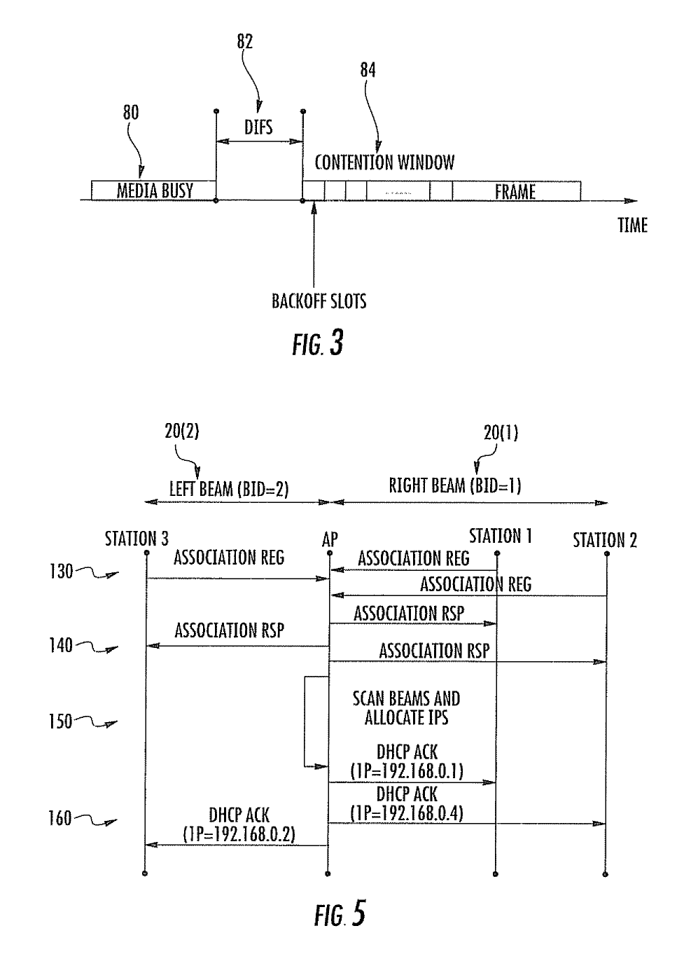

Referring initially to FIGS. 1 and 2, an 802.11 wireless local area network (WLAN) 10 includes client stations 12(1)-12(3), and an access point 14 operating with an antenna array 16 in which a directional antenna beam 20(1)-20(2) may be selected for receiving uplink transmissions for the client stations. The client stations may be generally referred to by reference 12, and the directional antenna beams may be generally referred to by reference 20.

The antenna array 16 comprises a plurality of antenna elements 18(1)-18(N) for generating N antenna beams, including one or more directional antenna beams 20 and an omni-directional antenna beam 22. For purposes of illustrating the present invention, the antenna array 16 may be a trident antenna that generates 3 antenna beams: two directional antenna beams 20(1), 20(2) plus an omni-directional antenna beam 22, where N=3, for example. The client stations 12 may be personal computers operating with wireless network cards, for example, and primarily use omni-directional antennas.

The use of directional antenna beams 20 during uplink transmissions from the client stations 12 improve the throughput of the WLAN 10, and increase the communication range between the access point 14 and the client stations. This is advantageously done without introducing overhead to the uplink transmissions.

A directional antenna beam 20 provides a high signal-to-noise ratio in most cases, thus allowing the link to operate at higher data rates. The PHY data rates for 802.11b links are 1, 2, 5.5, and 11 Mbps, and the rates for 802.11a are 6, 9, 12, 18, 24, 36, 48 and 54 Mbps. The 802.11g devices support the same data rates as 802.11a devices as well as the rates supported by 802.11b rates.

The access point 14 includes a beam switching unit 30 connected to the smart antenna 16, and a transceiver 32 connected to the beam switching unit. A controller 40 is connected to the transceiver 32 and to the beam switching unit 30. The controller 40 includes a processor 42 for executing an antenna steering algorithm 18.

Alternatively, the antenna steering algorithm 18 may operate on an 802.11 PHY/MAC chipset instead of the illustrated processor 42. The PHY/MAC chipset includes the illustrated PHY layer 43 and the MAC layer 44.

The IEEE 802.11 standard defines two modes of operations: distributed coordinated function (DCF) and point coordinated function (PCF). The PCF mode is a centralized MAC protocol that supports collision-free and time-bounded services. The DCF mode is a form of carrier sense multiple access with collision avoidance (CDSMA/CA). The collision avoidance part of the DCF mode includes a backoff mechanism or algorithm 47.

The DCF mode specifies that a client station 12 must wait a distributed interframe space (DIFS) period 82 after it senses that the channel 80 is idle and start its contention window 84, as illustrated by the DCF data transmission scheme in FIG. 3. In the 802.11 standard, there are a maximum of 1023 backoff slots, and the backoff algorithm is not standardized. Currently, the 1023 backoff timeslots are for the 802.11b/g standard. Future standards may use a different number of timeslots, as readily appreciated by those skilled in the art.

Normally, the client station 12 could start transmission on the uplink at any backoff time slot within its contention window 84. However, in order for the access point 14 to know which directional antenna to use for any of the client stations 12, the client stations only transmit at certain back-off time slots in accordance with the present invention. As will be discussed in greater detail below, each client station 12 is assigned an IP address, and a preferred antenna beam id or identification is built into this address. The client stations 12 only transmit at the backoff slots allowed for the preferred antenna beam id assigned to it. At each backoff time slot, the access point 14 will then listen with the antenna mode assigned to this time slot.

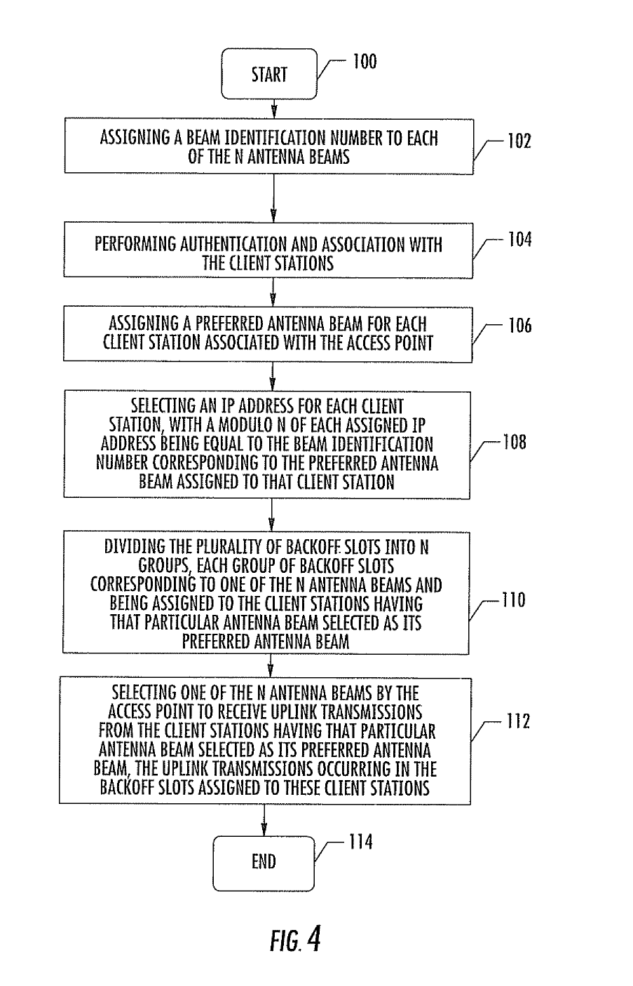

A flowchart for providing uplink transmissions in the WLAN 10 between the client stations 12 and the access point 14 will now be discussed with reference to FIG. 4. Form the start (Block 100), a beam identification number is assigned to each of the N antenna beams at Block 102. For illustrative purposes, the access point 14 has two directional antenna beams 20(1), 20(2) and an omni-directional antenna beam 22. The omni-directional antenna beam 22 is assigned a beam id=0, the right directional antenna beam 20 is assigned a beam id=1, and the left directional antenna beam 20 is assigned a beam id=2. There are a total of 3 antenna beams, so that N=3.

The access point performs authentication and association at Block 104 with the client stations 12. A preferred antenna beam is selected or found for each client station 12 associated with the access point at Block 106. Depending on the position of the client stations 12 with respect to the access point 14, the preferred antenna beam may be one of the directional antenna beams 20(1), 20(2) or the omni-directional antenna beam 22.

An IP address is assigned at Block 108 to each client station 12. A dynamic host configuration protocol (DHCP) is used by the access point 14 to allocate an IP addresses for each client station 12 associated therewith. In accordance with the present invention, an IP address is assigned so that a modulo N of each assigned IP address is equal to the beam identification number corresponding to the preferred antenna beam 20 selected for that client station 12.

The IP address allocation scheme is illustrated in FIG. 5. The right directional antenna beam 20(1) has beam id=1, and the left directional antenna beam 20(2) has beam id=2. Not shown is the omni-directional antenna beam 22 having beam id=0.

After the client stations 12 request association in section 130 and the access point 14 responds in section 140, the access point selects the preferred antenna beam for each client station in section 150. At this point, the access point 14 assigns an IP address to a client station such that the last octet of IP mod(N)=beam id, where N=the number of antenna beams, in section 160. The IPv4 address has 4 octets separated with a decimal. To make the calculation easier, only the last octet is used. As best illustrated in FIG. 5, the client stations 12(1), 12(2) under the right directional antenna beam 20(1) are assigned IP addresses 192.168.0.1 and 192.168.0.4 and the client station 12(3) at the left directional antenna beam 20(2) is assigned IP address 192.168.0.2.

The mod is the modulo of the IP address. As readily understood by those skilled in the art, a modulo is an operation related to division that returns the remainder. When a modulo N of each IP address is performed, where N=3 in the illustrated example, the result is the id for the preferred antenna beam selected for that particular client station 12.

For IP address 192.168.0.1, which is assigned to client station 20(1), modulo 3 of “1” provides a remainder of 1, which corresponds to the right directional antenna beam 20(1). Client station 12(2) is also assigned the right directional antenna beam since its IP address is 192.168.0.4. Modulo 3 of “4” which is rounded down to “1” also provides a remainder of 1. This corresponds to the right directional antenna beam 20(1).

For client station 20(3), its IP address is 192.168.0.2. Modulo 3 of “2” provides a remainder of 2, which corresponds to the left directional antenna beam 20(2). If another client station had an assigned IP address of 192.168.0.3, for example, modulo 3 of “3” provides a remainder of 0, which corresponds to the omni-directional antenna beam 22.

The method further comprises at Block 110 of dividing the plurality of backoff slots into N groups, with each group of backoff slots corresponding to one of the N antenna beams and being assigned to the client stations 12 having that particular antenna beam selected as its preferred antenna beam. In particular, each group of backoff slots is divided such that a modulo N of each backoff slot position in a particular group equals the beam id assigned to the client stations having this particular group of backoff slots.

In the illustrated example, client stations 12(1), 12(2) under the right directional antenna beam 20(1) could only start transmitting at backoff slots 1,4,7,10 . . . . Client station 12(3) under the left directional antenna beam 20(2) could only transmit at backoff slots 2,5,8,11 . . . . Likewise, client stations under the omni-directional antenna beam 22 could only transmit at backoff time slot 3,6,9,12 . . . . If a modulo 3 is performed on any of these backoff slots, the result is the beam id assigned to the client station 12 having that time slot. For example, modulo 3 of backoff slot “10” =1; modulo 3 of backoff slot “11” =2 and modulo 3 of backoff slot “12” =0.

The access point 14 selects one of the N antenna beams at Block 112 to receive uplink transmissions from the client stations having that particular antenna beam selected as its preferred antenna beam, with the uplink transmissions occurring in the backoff slots assigned to these client stations.

The access point 14 will use the left directional antenna beam 20(2) for reception at backoff slots 1,4,7,10 . . . , will use the right directional antenna beam 20(1) for reception at backoff slots 2,5,8,11 . . . , and will use the omni-directional antenna beam 22 for reception at backoff slots 3,6,9,12 . . . .

Since each client station 12 is always listening to the medium and updates its NAV, all client stations are synchronized during the period from the last time the medium 80 is busy to the last time the medium is busy +DIFS +1023 backoff slots. If there is not a transmission after the medium 80 becomes idle after DIFS +1023 backoff slots, the access point 14 will using the omni-directional antenna beam 22 for reception and the client station will transmit as defined in the 802.11 standard.

If a client station 12 wakes up from a power save mode and does not know when the last packet is transmitted, it waits up to DIFS+1023 backoff slots before starting transmit.

If there is a packet transmitted during this time, then the client station 12 knows when the access point 14 will listen on the omni-directional antenna beam 22, and could start transmitting at a backoff time slot when the access point 14 is using the omni-directional antenna beam 22. If there is not packet transmitted during this time, then the client station 12 could start to transmit because the access point 14 is listening on the omni-directional antenna beam 22 after DIFS +1023 backoff slots.

For a new client station to enter the WLAN 10, it should transmit an authentication request, an association request or a probe request at the backoff time slot when the access point 14 is using the omni-directional antenna beam 22. In the illustrated example, the backoff slots are 0,3,6,9,12 . . . for the omni-directional antenna beam 22.

When the access point 14 finds that a client station 12 has moved and the preferred antenna beam for that station has changed, the access point does the following: stops transmitting packets to that client station 12; uses the DHCP protocol to update the client station IP address so it will transmit at the right time and the access point 14 can receive it with the right antenna beam; and start transmitting to that client station using the new IP address. The method ends at Block 114.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A method for providing uplink transmissions in an 802.11 wireless communication network between a plurality of client stations and an access point, the access point operating with an antenna array generating N antenna beams, and the uplink transmissions occurring during a contention window comprising a plurality of backoff slots, the method comprising:
assigning a beam identification number to each of the N antenna beams;
selecting a preferred antenna beam for each client station associated with the access point;
informing each client station of its selected preferred antenna beam;
dividing the plurality of backoff slots into N groups, each group of backoff slots corresponding to one of the N antenna beams and being assigned to the client stations having that particular antenna beam selected as its preferred antenna beam; and
selecting one of the N antenna beams by the access point to receive uplink transmissions from the client stations having that particular antenna beam selected as its preferred antenna beam, the uplink transmissions occurring in the backoff slots assigned to these client stations.

2. A method according to claim 1 wherein the informing is based upon assigning an IP address to each client station, with a modulo N of a last octet of each assigned IP address being equal to the beam identification number corresponding to the preferred antenna beam selected for that client station.

3. A method according to claim 2 wherein each group of backoff slots is divided such that a modulo N of each backoff slot position in any particular group equals the beam identification number assigned to the client stations having this particular group of backoff slots.

4. A method according to claim 1 wherein the 802.11 wireless communication network is operating in a distributed coordinated function (DCF) mode, and further comprising each client station sensing if a communications channel is idle, and if so, then waiting a distributed interframe space (DIFS) period before initiating uplink transmission to the access point on its assigned backoff slots within the contention window.

5. A method according to, claim 1 wherein the N antenna beams include an omni-directional antenna beam and a plurality of directional antenna beams.

6. A method according to claim 1 wherein the contention window comprises 1023 backoff slots.

7. A method according to claim 1 further comprising performing authentication and association with the client stations.

8. A method according to claim 1 wherein the client stations associated with the access point are synchronized.

9. A method according to claim 5 wherein if a communications channel is idle, and there are no uplink transmissions after the plurality of backoff slots has passed, then the access point selects the omni-directional antenna beam as the preferred antenna beam for any client station initiating uplink transmissions with the access point.

10. A method according to claim 1 wherein if the access point determines that a client station has moved so that its preferred antenna beam needs to be updated, then the access point stops transmitting to the client station, updates the preferred antenna beam and updates the assigned IP address based upon the beam id corresponding to the updated preferred antenna beam.

11. A method according to claim 5 wherein if a client station wakes up from a power save mode and does not know when a data packet was last transmitted, then the client station waits a predetermined amount of time plus until after the plurality of backoff slots has passed before initiating uplink transmissions to the access point at a backoff slot associated with the omni-directional antenna beam.

12. A method according to claim 11 wherein if the client station knows when the data packet was last transmitted, then the client station knows when the access point will listen on the omni-directional antenna beam and initiate uplink transmissions with the access point at a backoff slot associated with the omni-directional antenna beam.

13. A method according to claim 1 wherein a new client station associating with the access point initiates uplink transmissions with the access point at backoff slots associated with the omni-directional antenna beam.

14. An access point comprising:
an antenna array generating N antenna beams;
a controller coupled to said antenna array for selecting one of the N antenna beams for receiving uplink transmissions from client stations occurring during a contention window comprising a plurality of backoff slots; and
a transceiver coupled to said controller and to said antenna array and comprising a backoff algorithm module for performing the following
assigning a beam identification number to each of the N antenna beams,
selecting a preferred antenna beam for each client station associated with the access point,
informing each client station of its selected preferred antenna beam,
dividing the plurality of backoff slots into N groups, each group of backoff slots corresponding to one of the N antenna beams and being assigned to the client stations having that particular antenna beam selected as its preferred antenna beam, and
selecting one of the N antenna beams to receive uplink transmissions from the client stations having that particular antenna beam selected as its preferred antenna beam, the uplink transmissions occurring in the backoff slots assigned to these client stations.

15. An access point according to claim 14 wherein the informing is based upon assigning an IP address to each client station, with a modulo N of a last octet of each assigned IP address being equal to the beam identification number corresponding to the preferred antenna beam selected for that client station.

16. An access point according to claim 15 wherein said backoff algorithm module divides each group of backoff slots such that a modulo N of each backoff slot position in a particular group equals the beam identification number assigned to the client stations having this particular group of backoff slots.

17. An access point according to claim 14 wherein said antenna array generates an omni-directional antenna beam and a plurality of directional antenna beams.

18. An access point according to claim 14 wherein the access point is operating in an 802.11 wireless communication network.

19. An access point according to claim 14 wherein the contention window comprises 1023 backoff slots.

20. An access point according to claim 14 wherein said transceiver performs authentication and association with the client stations.

21. An access point according to claim 14 wherein said transceiver is synchronized with the associated client stations.

22. An access point according to claim 17 wherein if a communications channel is idle, and there are no uplink transmissions after the plurality of backoff slots has passed, then said controller selects the omni-directional antenna beam as the preferred antenna beam for any client station initiating uplink transmissions.

23. An access point according to claim 14 wherein if said transceiver determines that a client station has moved so that its preferred antenna beam needs to be updated, then said transceiver stops transmitting to the client station, updates the preferred antenna beam and updates the assigned IP address based upon the beam id corresponding to the updated preferred antenna beam.
